(19) United States
(12) Patent Application Publication
(10) Pub. No.: US 2008/0232088 A1
(43) Pub. Date: Sep. 25, 2008

(54) Acoustic Light-Emitting Device

(75) Inventor: Dirk Hente, Wuerselen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/064,087

(22) PCT Filed: Aug. 11, 2006
(86) PCT No.: PCT/IB2006/052774

§ 371 Date: Feb. 19, 2008

(30) Foreign Application Priority Data
Aug. 22, 2005 (EP) 05107685.9

(51) Int. Cl. F21V 33/00; H01J 1/62; H04M 1/22; H04R 25/00

(52) U.S. Cl. 362/86; 313/498; 381/150

(57) ABSTRACT

The present invention relates to an acoustic light-emitting device (10,10′, 10″, 10′″, 10″″) comprising a sheet-like element (20) with a layer structure, which performs a predetermined operation in response to a signal applied thereto, at least one transducer (40), being the source of the signal by exciting bending waves to the sheet-like element (20), in that the sheet-like element (20) comprises a light-emitting device (30) with at least a first electrode layer (31), a light-emitting layer (32) and a second electrode layer (33).

This invention relates to an acoustic light-emitting device.

It is known that conventional loudspeaker utilise a cone-type membrane as a sound radiator. In this case sound radiation can be achieved by attaching an electro-dynamic type voice coil transducer to the smaller end of the membrane. The transducer drives the coil to move back and forth. In the US 2002/0118847 A1 a loudspeaker is described using the vibration of a panel to generate a sound, whereby a transducer induces flexural vibrations of the panel.

An illumination is often needed in places, where loudspeakers are used. The equipment of a loudspeaker with a reflective surface is well known. Illumination of a large area can be achieved by using a lamp, which is directed to the surface of the loudspeaker. It is also the state of the art that a device comprises a combination of sound and light producing elements. For example, light-emitting diodes disposed around a conventional loudspeaker are well known. One of the disadvantages is that the quality of the light and of the sound produced by this acoustic light-emitting device is not satisfactory.

The object of the invention is to improve the above acoustic light-emitting device. In particular, an object of the present invention is to provide an acoustic light-emitting device with a compact and simple set-up.

This object is achieved by an acoustic light-emitting device as taught by claim 1 of the present invention.

Accordingly, an acoustic light-emitting device is provided, comprising a sheet-like element with a layer structure, which performs a predetermined operation in response to a signal applied thereto, and at least one transducer, being the source of the signal by exciting bending waves to the sheet-like element, whereby the sheet-like element comprises a light-emitting device with at least a first electrode layer, a light-emitting layer (an active layer) and a second electrode layer.

The inventors have studied the problem of combining sound and light producing elements very carefully and found the solution in a layer structure of a panel-form, sheet-like element carrying a light-emitting device, whereby the sheet-like element acts as a loudspeaker. One of the essential ideas of this invention is based on the fact, that the present acoustic light-emitting device comprises a sound radiation sheet-like element, whereby a transducer excites vibrational modes to said element. Preferably, the transducer can be an electro-mechanical system, which transforms electrical signals into movements of a coil. By coupling the transducer with the sheet-like element, the movement of the coil is transferred to the element, which is bent. Thus, vibrational modes are excited, while sound is radiated. In a preferred embodiment of the invention the sheet-like element has a planar structure. Advantageously, the sheet-like element can easily be used for different applications.

In a preferred embodiment the sheet-like element is the light-emitting device, whereby the transducer is fixed directly to one electrode layer. The light-emitting layer is placed between the first and the second electrode layer. Preferably, the light-emitting device is an inorganic electro-luminescent device or an organic light-emitting device (OLED). One of the main advantages of using OLEDs in the present invention is that high efficient and high luminance acoustic devices can be achieved that are flat and compact. It is even possible to use OLEDs on flexible substrates like a foil. Thus, the OLED can be fixed with the sheet-like element easily, whereby the sheet-like element can comprise any possible shape. Alternatively, the acoustic light-emitting device in combination with said OLED can be used in systems with controllable colour. Therefore the present invention offers new opportunities in acoustic light-emitting devices, which can be used independently either as a light source, a loudspeaker or a combination of both.

Preferably, the OLED is a bottom-emitting device or a top-emitting device. A bottom-emitting device emits light through a transparent substrate while a top-emitting device emits light to the side opposite to the substrate. In the latter case, the substrate can be transparent or non-transparent. It has been found that the use of a layer device can be beneficial for changing and/or modifying the properties for bending wave excitation of the sheet-like element. The layer device can be placed between the transducer and the light-emitting device. Another possibility is to place the layer device on the light-emitting device at the opposite side of the transducer. Certainly, using both arrangements in one acoustic light-emitting device is also possible.

According to a preferred embodiment of the present invention, the layer device comprises at least one layer element, which can be a substrate layer and/or a cover layer for the light-emitting device.

In a preferred embodiment of the invention, the layer device is a multi-layer with at least two layer elements. The layer elements can be made of a homogeneous isotropic material and/or homogeneous anisotropic material and/or glass and/or metal and/or plastic and/or comprises a foam structure and/or a honeycomb structure and/or a fibered structure and/or a single material structure and/or composite material structure. Furthermore, the layer device of the sheet-like element can be made of paper or aluminium achieving a greater stiffness and stability as well as a better thermal management of the OLED. Preferably, the homogeneous materials are placed on the non-emitting side of the acoustic light-emitting device.

Advantageously, the layer device comprises a first and a second layer element, whereby a core as a third layer element is placed between the first and the second layer element. The mentioned layer device is connected to the OLED, thus the acoustic light-emitting device has a double sandwich structure. Advantageously, the layer device includes a rigid lightweight core, whereby at least one transducer is coupled to the sheet-like element in such a way that bending wave energy permits radiation of sound. One of the functions of the core is keeping the layer elements of the sheet-like element at a distance to achieve a specific bending stiffness. According to another embodiment of the present invention the core can be a foam. It is possible that the acoustic light-emitting device comprises only one or a plurality of transducers, which are connected to said sheet-like element. Said transducers can be mounted at all possible sides of the layer structure of the sheet-like element.

Another advantage of the proposed layer structure is that thinner substrate materials can be used for the OLED because the core of the layer device gives the necessary mechanical support. According to a preferred embodiment the OLED comprises an organic layer placed between two electrodes on top of the substrate and the cover layer positioned at the opposite side of said substrate. Preferably, the cover layer and/or the substrate layer are made of transparent material depending on a bottom or a top-emitting OLED. Additional layer elements can be used if the OLED substrate does not have the required mechanical properties. Advantageously, the first and second layer element and the core of the layer device are made of aluminium, reducing the thermal resistance of the acoustic light-emitting device.

According to another preferred embodiment of the present invention, the acoustic light-emitting device comprises electrical and electronic circuits to control the light-emitting device and/or the sound emitting device, which are embedded in the core or in one of the layer elements of the layer device.

The acoustic light-emitting device according to the present invention can be used in a variety of systems, e.g. household application systems, shop lighting systems, home lighting systems, accent lighting systems, spot lighting systems, fibre-optics application systems, projection systems, self-lit display systems, pixelated display systems, segmented display systems, warning sign systems, medical lighting application systems, mobile phone display systems, indicator sign systems, or decorative lighting systems.

The light-emitting device according to the present invention is particularly configured to generate light for inside and outside providing a sufficient intensity of an effective illumination, whereby the term “light” includes visible and invisible light (e.g. UV, IR) or a combination of both.

The aforementioned components, as well as the claimed components and the components to be used in accordance with the invention in the described embodiments, are not subject to any special exceptions with respect to their size, shape, material selection and technical concept so that the selection criteria known in the pertinent field can be applied without limitations.

Additional details, characteristics and advantages of the object of the invention are disclosed in the sub-claims and the following description of the respective figures,—which in an exemplary fashion—show several preferred embodiments of the acoustic light-emitting device according to the invention.

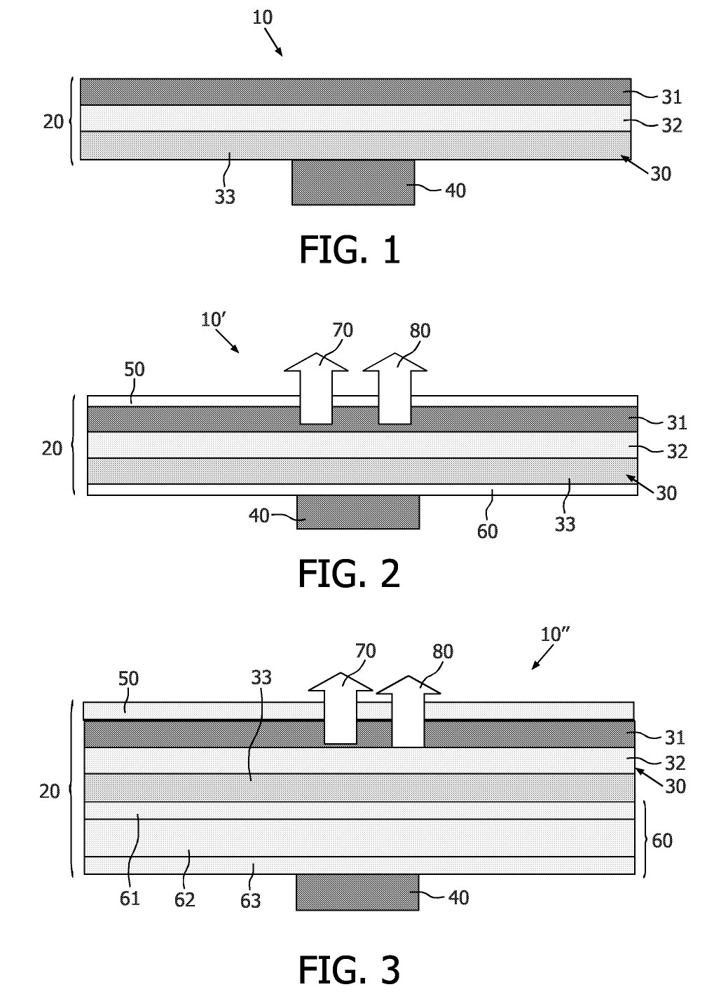

FIG. 1 shows a very schematic cross sectional view of an acoustic light-emitting device according to a first embodiment of the present invention,

FIG. 2 shows a very schematic cross sectional view of an acoustic light-emitting device according to a second embodiment of the present invention,

FIG. 3 shows a very schematic view of an acoustic light-emitting device according to a third embodiment of the present invention,

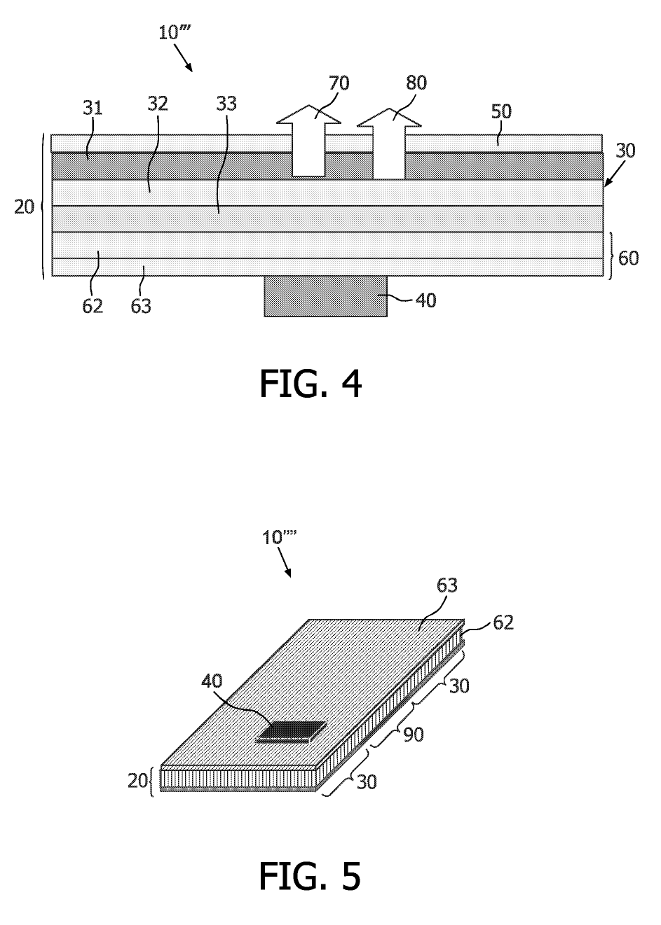

FIG. 4 shows a very schematic cross sectional view of an acoustic light-emitting device according to a fourth embodiment of the present invention and

FIG. 5 shows a very schematic perspective view of an acoustic light-emitting device according to a fifth embodiment of the present invention.

FIG. 1 shows an acoustic light-emitting device 10 comprising a sheet-like element 20, which has a panel-form. In this embodiment the sheet-like element 20 having a layer structure is a light-emitting device 30, particularly an organic light-emitting device (OLED) 30 with a first electrode layer 31, a second electrode layer 33 and a light-emitting layer 32, which is placed between the first 31 and the second electrode layer 33 deposited on a substrate not shown in FIG. 1. The substrate layer can be glass, a metal plate or a foil etc. The substrate is transparent with a bottom-emitting device. The substrate can be transparent or non-transparent with a top emitting-device. The layers 31,32,33 are formed by thin film deposition techniques such as vapour deposition, sputtering and/or wet chemical deposition techniques. A transducer 40 is fixed on the sheet-like element 20, directly, whereby the transducer 40 can be connected to the sheet-like element 20 by a form fit and/or an adhesive bond and/or a frictional connection.

According to FIG. 1 the transducer 40 excites the light-emitting device 30, which performs a pre-determined operation in response to the signals induced by the transducer 40. This means that flexural vibrations are induced into the light-emitting device 30, which are transformed into acoustic information like radiated sound. The transducer 40 comprises a permanent magnet, a voice coil unit and a flexible suspension, which are not shown explicitly, whereby the transducer 40 is mechanically coupled to the light-emitting device 30 in such a way that bending waves can be excited. The waves are transmitted to the light-emitting device 30, which responds in a pre-determined way by generating sound like a loudspeaker.

In FIG. 2 an acoustic light-emitting device 10′ is shown with a sheet-like element 20 comprising an OLED 30 according to FIG. 1. However, the sheet-like element 20 is connected to two layer devices 50 and 60. The layer device 60 is placed between the transducer 40 and the light-emitting device 30 and serves as a substrate layer 60 for the OLED 30. On the opposite side of the transducer 40, the layer device 50 is fixed on the OLED 30 as a cover layer 50. In this embodiment the light-emitting device 30 is a top-emitting OLED 30. The leaving light 80 is shown with the reference number 80. The cover layer 50 is made of a transparent material, for example glass or plastic. Both layers 50,60, which protect and seal the light-emitting device 30, can also be multi-layers.

According to FIG. 2 it is possible that the sheet-like element 20 comprises only one of the above layer devices 50,60 connected to the light-emitting device 30. That means that in one possible embodiment only the substrate layer 60 is used, and another embodiment of the invention comprises only the cover layer 50, now serving as the substrate for the light-emitting device 30. The generated sound has the reference number 70.

According to FIG. 3 the acoustic light-emitting device 10″ comprises an OLED 30 with a transparent cover layer 50 and a layer device 60, which is connected to the OLED 30 at the opposite side of the cover layer 50. The layer device 60 is a multi-layer with a first 61 and a second layer element 63, in that a core 62 is placed between the first 61 and the second layer element 63. The first layer element 61 is fixed to the second electrode layer 33 and the second layer element 63 is directly connected to the transducer 40. In another not shown embodiment a plurality of transducers 40 can be mounted on the sheet-like element 20. In this case the frequency range of the sheet-like element 20 can be extended additionally by proper selection of materials introducing anisotropy and proper excitation of bending waves with more than one transducer.

In the described embodiment of FIG. 3 the core 62 is a honeycomb core 62. Producing a high quality of sound 70 the light-emitting device 30 has a Young modulus and a density significantly higher than the sandwich structure of the layer device 60, especially of the first layer element 61, the second layer element 63 and the core 62. According to FIG. 3 the honeycomb structure 62 is made of aluminium, improving the bending stiffness and the thermal management of the whole device 10″. It has been found that a honeycomb structure made of paper is also acceptable for lightweight applications (planes, mobile phones etc.). The material used for the first 61 and the second layer element 63 has to be adapted to the core material 62 of the acoustic light-emitting device 10″.

The light-emitting device 30 of FIG. 3 can be a bottom-emitting OLED 30. In this case the cover layer 50 is the substrate layer of the bottom-emitting OLED 30, in that the first electrode layer 31 (the anode) is made of a transparent material, for example ITO (indium tin oxide) or r p-doped silicon. The light-emitting device 30 can also be a top-emitting device 30. According to this embodiment the first layer element 61 is the substrate layer of the OLED 30. The outside layer 50 protects the light-emitting device 30 against environmental influences. In other embodiments the material of the layer devices 50,61,62,63 can also be plastic, having the advantages that plastic is cheaper to produce and can easily be transformed in non-planar forms.

In FIG. 4 an acoustic light-emitting device 10′″ is shown with a sheet-like element 20 comprising an OLED 30, a cover layer 50, a layer device 60 and a transducer 40. The layer device 60 comprises a core 62 and a second layer element 63. In this embodiment the core 62 is fixed directly to the OLED 30. The core 62 serves as a mechanical support for the OLED 30 during the drive of the acoustic light-emitting device 10′″. The second layer element 63 and the core 62 can be made of aluminium to reduce thermal resistance. A plate can also be placed, between the light-emitting device 30 and the core 62.

FIG. 5 shows an acoustic light-emitting device 10″″, which substantially comprises the same characteristics of the embodiment of FIG. 4. The essential difference to FIG. 4 is that the OLED 30 includes segmented electrodes 33. An area 90 of non-emitting light is positioned between these electrode layers 30. The transducer 40 is fixed on the second layer element 63, in that the core layer 62 is placed between the OLED 30 and the second layer element 63.

According to FIGS. 1-5 the transducer 40 is connected to a controller unit, which is not shown explicitly. This connection can be achieved with cables, pipes and/or circuits, which are embedded in the core 62. According to another alternative embodiment said cables, pipes and/or circuits can be embedded at least in the first 61 and/or the second layer element 63.

Also, the light-emitting devices 30 of the shown acoustic light-emitting devices 10,10′, 10″, 10′″, and 10″″ can be LEDs (inorganic light-emitting devices) or ELs (electro-luminescent materials). Advantageously, with all above mentioned light-emitting devices 30 a thin acoustic light-emitting device 10,10′, 10″, 10′″, 10″″ can be built. By combining one of said light-emitting devices 30 with the sheet-like element 20, an acoustic light-emitting device 10, 10′, 10″, 10′″, 10″″ is achieved that radiates acoustic waves from its surface. The device 10,10′, 10″, 10′″, 10″″ can be scaled to any size and form suitable for different indoor and outdoor applications, where sound and light is needed.

In the previous embodiments, the transducer 40 is arranged at the non-light-emitting side of the acoustic light-emitting device 10,10′, 10″, 10′″, 10″″. In an alternative embodiment, the transducer 40, or an array of transducers 40, is arranged on the light-emitting side of the acoustic light-emitting device.

The number of layers of the layer devices 50,60, their properties like surface mass, stiffness, and the number, the type and size of the transducers, can be modified in order to improve the desired acoustic and optical properties of the acoustic light-emitting device 10,10′, 10″, 10′″, 10″″.

### LIST OF NUMERALS

10 acoustic light-emitting device
10′ acoustic light-emitting device
10″ acoustic light-emitting device
10′″ acoustic light-emitting device
10″″ acoustic light-emitting device
20 sheet-like element
30 light-emitting device, OLED
31 first electrode layer
32 light-emitting layer (active layer)
33 second electrode layer
40 transducer
50 layer device
60 layer device
61 first layer element
62 core
63 second layer element
70 emitted light
80 emitted sound
90 non light-emitting area

1. An acoustic light-emitting device (10,10′, 10″, 10′″, 10″″) comprising:
a sheet-like element (20) with a layer structure, which performs a predetermined operation in response to a signal applied thereto,
at least one transducer (40), being the source of the signal by exciting bending waves to the sheet-like element (20),
wherein the sheet-like element (20) comprises a light-emitting device (30) with at least a first electrode layer (31), a light-emitting layer (32) and a second electrode layer (33).

2. The acoustic light-emitting device (10,10′,10″,10′″,10″″) as claimed in claim 1, wherein the light-emitting device (30) is an inorganic electro-luminescent device.

3. The acoustic light-emitting device (10,10′,10″,10′″,10″″) as claimed in claim 1, wherein the light-emitting device (30) is an organic light-emitting device (OLED).

4. The acoustic light-emitting device (10′,10″,10′″,10″″) according to claim 1, wherein the sheet-like element (20) comprises a layer device (50,60) connected to the light-emitting device (30), in order to change and/or modify the properties for bending wave excitation of the sheet-like element (20).

5. The acoustic light-emitting device (10′,10″,10′″,10″″) according to claim 4, wherein the layer device (60) is placed between the transducer (40) and the light-emitting device (30) and/or the layer device (50) is placed on the light-emitting device (30) at the opposite side of the transducer (40).

6. The acoustic light-emitting device (10′,10″,10′″,10″″) according to claim 4, wherein the layer device (50,60) comprises at least one layer element (50,60,61,62,63).

7. The acoustic light-emitting device (10′, 10″,10′″,10″″) according to claim 1, wherein the layer element (50,60,61,62,63) is a substrate layer and/or a cover layer for the light-emitting device (30).

8. The acoustic light-emitting device (10′,10″,10′″,10″″) according to claim 7, wherein the layer element (50,60,61,62,63) is made of a homogeneous isotropic material and/or homogeneous anisotropic material and/or glass and/or metal and/or plastic and/or paper and/or comprises a foam structure and/or a honeycomb structure and/or a fibered structure and/or a single material structure and/or composite material structure.

9. The acoustic light-emitting device (10,10′,10″,10′″,10″″) according to claim 1, wherein the transducer (40) is an electromechanical device.

10. The acoustic light-emitting device (10″″) according to claim 1, wherein the light-emitting device (30) comprises segmented electrodes (33).
